(19) United States
(12) Patent Application Publication
(10) Pub. No.: US 2023/0374628 A1
(43) Pub. Date: Nov. 23, 2023

(54) PROCESS FOR PRODUCING SPHERICAL POWDERS OF NOVEL MULTICOMPONENT BASED SHAPE MEMORY ALLOYS AND ALLOYS MADE BY THE PROCESS

(71) Applicant: COUNCIL OF SCIENTIFIC AND INDUSTRIAL RESEARCH, Lynnwood (ZA)

(72) Inventor: Silethelwe CHIKOSHA, Pretoria (ZA)

(73) Assignee: COUNCIL OF SCIENTIFIC AND INDUSTRIAL RESEARCH, Lynnwood (ZA)

(21) Appl. No.: 18/252,879

(22) PCT Filed: Nov. 10, 2021
(86) PCT No.: PCT/ZA2021/050065

§ 371 Date: May 14, 2023

(30) Foreign Application Priority Data
Nov. 13, 2020 (ZA) 2020/07076

(51) Int. Cl. C22C 1/04; B22F 1/065; B22F 9/04; B22F 3/14; B22F 9/08

(52) U.S. Cl. CPC C22C 1/0458; B22F 1/065; B22F 9/04; B22F 3/14; B22F 9/082; C22C 1/0466; C22C 1/0433; B22F 2009/041; B22F 2998/10; B22F 2009/0824; B22F 2999/00; B22F 2201/20; B22F 2202/13; B33Y 70/00

(57) ABSTRACT

The invention provides a process for producing powders of novel multicomponent based shape memory alloys. The memory shape alloys are made by combining at least 4 to 6 elements selected from a combination of group IUPAC 4 transition metal (Ti) with group IUPAC 10 transition metals (Ni and Pt) to make up the basic ternary alloy with further additions of 1 up to 3 other transition metals making a final alloy of a maximum of 4 up to 6 components.

### FIELD OF THE INVENTION

This invention provides a process for producing spherical powders of novel multicomponent based shape memory alloys and a novel multicomponent alloy.

### BACKGROUND TO THE INVENTION

There is a growing demand for developing smart materials that can be used for application at high temperatures. Currently, there is commercially available TiNi which is used at 100° C. and below. Ternary additions of Pd and Pt to TiNi have been explored for temperatures up to 500° C. High entropy alloys have been explored and the alloys with different alloys that can be used up to 500° C. Furthermore, recent studies show the TiNiPd system has been developed by quaternary and quinary additions of Hf and Zr targeted for applications of around 800° C. Some of the quinary alloys that have been developed up to 800° C. could also be considered to be high entropy alloys (HEAs). Other HEAs investigated to date do not contain palladium have shown transformation temperatures only up to 700° C. However, there is still a need to develop ultra high temperature shape memory alloys, in the region of 800° C. and above. These are specially needed for aeronautic actuator applications among others. To date, TaRu, NbRu, TiPt binary and TiPt ternary alloys have been investigated and show very minimal in terms of hysteresis, creep, microstructural stability and creep and oxidation.

The inventor is aware of the publication by Demircan Canadinc, William Trehern, Ji Ma a, Ibrahim Karaman, Fanping Sun, Zaffir Chaudhry, Ultra-high temperature multi-component shape memory alloys, Scripta Materialia 158 (2019) 83-87, which paper describes a process of making ultra high temperature shape memory alloys based using quartenary and quinary equiatomic and near equatomic based of TiNi with additions of Hf, Zr, Pd and were able to achieve transformation to below 800° C. Although they disclose the use of Pd and Zr and Hf, they make the alloys by melting and the product is not in the form of spherical powders but it's in the form of an ingot or electrode.

Over and above the demand for the materials themselves, there is a growing demand for additive manufacturing as a manufacturing technology of the future. Additive manufacturing together with processes such as metal injection moulding and hot pressing use spherical powders as feedstock materials to make products. The ability to generate any new alloys in the form of spherical powders creates opportunities to manufacture them using the above mentioned technologies.

### SUMMARY OF THE INVENTION

According to a first aspect of the invention, there is provided a process for producing spherical powders of novel multicomponent based shape memory alloys, said alloys made by combining at least 4 to 6 elements selected from a combination of group IUPAC 4 transition metal with group IUPAC 10 transition metals to make up the basic ternary alloy with further additions of 1 up to 3 other transition metals making a final alloy of a maximum of 4 up to 6 components.

The process wherein combination includes at least Ti, Ni and Pt.

The process wherein the composition of basic ternary alloy components may vary between 10 and 35 at. % and 5 to 25 at. % for the 3 other transition alloying metals.

One or more processes selected from the processes below may be used to make the spherical powders:
mechanical alloying (MA) followed by spheroidization;
press and sinter (P&S) followed by vacuum induction melting (VIM);
spark plasma sintering (SPS) followed by vacuum induction melting (VIM);
loose sintering followed by Electrode induction melting gas atomisation (EIGA);
plasma rotating electrode process (PREP); and
centrifugal atomisation.

The process wherein the feedstock is either in powder or sponge form.

The process wherein the powders produced may be spherical in shape.

The process wherein spherical shaped powders may show the presence of a martensitic transformation with a temperature range from 800 to 1500° C.

The process wherein the alloy thus produced shows super-elasticity, work output capabilities, and high temperature mechanical and thermal stability properties on cycling.

The alloys may be processed by either spheriodisation or atomisation.

The powders may be used for additive manufacturing (AM), metal injection moulding (MIM), Hot pressing (HP), or the like.

Thus, in accordance with the invention, there is provided a process for producing spherical powders of multicomponent ultra high temperature shape memory alloy based on the TiNiPt ternary system by developing a quartenary, quinary (including high entropy alloys) and senary multicomponent alloys.

Specifically, there is provided a process for producing spherical powders of multicomponent alloys with martensitic transformation comprising of a ternary baseline alloy from the transition metals in group IUPAC 4 (Ti) and group IUPAC 10 (Ni and Pt) alloyed with one up to 3 additional elements from any of the transition metals.

The resulting alloy may be a single or multiple phase alloy with a martensitic transformation temperature range from 800 up to 1500° C. The alloy shows superelastic, shape memory properties and work output capabilities and high temperature mechanical and thermal stability properties on cycling.

The alloys produced may show a martensitic transformation at 600 up to 1500° C. with a small hysteresis ranging from 10° C. to 50° C., with work output capabilities of up to 6 J/cm³ and are thermally stable.

According to a further aspect of the invention, there are provided spherical powders of multicomponent based shape memory alloys, said alloys having at least 4 to 6 elements selected from a combination of group IUPAC 4 transition metal (Ti) with group IUPAC 10 transition metals (Ni and Pt) to make up the basic ternary alloy with further addition of 1 to 3 other transition metals making a final alloy having a maximum of 4 to 6 components.

Said memory alloys of which the composition of basic ternary alloy components may vary between 10 and 35 at. % and 5 to 25 at. % for the up to 3 other transition alloying metals.

The memory alloys may show the presence of a martensitic transformation with a temperature range from 800 to 1500° C.

Said memory alloys has super-elasticity, work output capabilities, and high temperature mechanical and thermal stability properties on cycling.

The memory alloys may be processed by either spheriodisation or atomisation.

The spherical powders of the memory alloys may be used for additive manufacturing (AM), metal injection moulding (MIM), Hot pressing (HP), or the like.

The invention thus extends to spherical powders of multicomponent ultra high temperature shape memory alloy based on the TiNiPt ternary system comprising one or more of quartenary, quinary (including high entropy alloys), and senary multicomponent alloys.

The spherical powders of multicomponent alloys with martensitic transformation may comprise of a ternary baseline alloy from the transition metals in group IUPAC 4 (Ti) and group IUPAC 10 (Ni and Pt) alloyed with one up to 3 additional elements from any of the transition metals, which alloy may be a single or multiple phase alloy with a martensitic transformation temperature range from 800 up to 1500° C.

The memory alloys produced may have a martensitic transformation at 600 up to 1500° C. with a small hysteresis ranging from 10° C. to 50° C., with work output capabilities of up to 6 J/cm³ and be thermally stable.

### DETAILED DESCRIPTION OF THE INVENTION BY WAY OF EXAMPLE

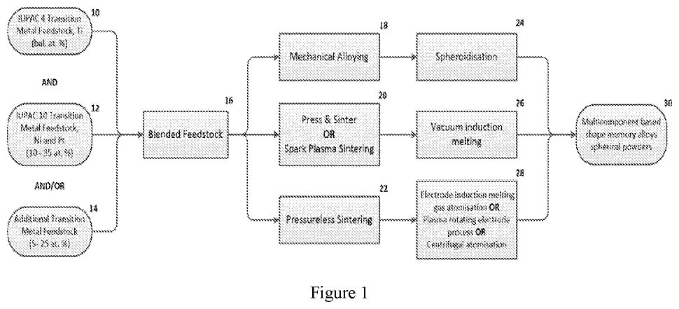

FIG. 1 shows a novel multicomponent spherical powder production process flow diagram for an approach for processing starting materials 10, 12, and/or 14 to produce spherical powders of novel multicomponent based shape memory alloy 30.

The method combines at least 4 to 6 elements selected from a combination of group IUPAC 4 transition metal such as titanium 10 with group IUPAC 10 transition metals 12 to make up the basic ternary alloy. Further additions of at least one and up to three other transition metals selected from Ta, Hf, Zr, Pd, Nb 14 making a final alloy of a maximum of 4 up to 6 components.

The starting materials are admixed to produce a blended feedstock 16. The disclosure further combines (i) mechanical alloying, MA 18 followed by spheroidization 24; or (ii) powder compaction and sintering via press and sinter, P&S or spark plasma sintering, SPS 20 followed by vacuum induction melting, VIM 26; or (iii) pressure-less sintering 22 followed by either electrode induction melting gas atomisation, EIGA or plasma rotating electrode process, PREP, or centrifugal atomisation 28.

### EXAMPLES

A detailed description of examples of the disclosed method to produce spherical powders of novel multicomponent based shape memory alloy is given below.

All examples are summarized in Tables 1 below.

TABLE 1

| | | | | First | Second | Third |
|---|---|---|---|---|---|---|
| | | | | Addi- | Addi- | Addi- |
| | | | | tional | tional | tional |
| | Ti | Ni | Pt | Element | Element | Element |
| | (at. %) | (at. %) | (at. %) | (at. %) | (at. %) | (at. %) |
| Example 1 | Bal. | 10-35 | 10-35 | — | — | — |
| Example 2 | Bal. | 10-35 | 10-35 | 5-25 | — | — |
| Example 3 | Bal. | 10-35 | 10-35 | 5-25 | 5-25 | — |
| Example 4 | Bal. | 10-35 | 10-35 | 5-25 | 5-25 | 5-25 |

### Example 1: Baseline Alloys (Table 1, Example 1)

To obtain a series of the ternary baseline alloys, mixtures of transition metal elements from group IUPAC 4 (Ti) and group IUPAC 10 (Ni and Pt) are provided with compositions varying between 10 and 35 at. %. According to the invention, the admixed elements can be in granular form or comprise powder characteristics. The mixing can be achieved by ball milling or other techniques known in the art. The admixed elemental materials are subsequently mechanical alloyed via high-energy ball milling performed in a Simoloyer CM01 (ZOZ GmbH, Germany) in batches under a protective atmosphere. The milled powder discharged from the mill is sieved and then spheriodised into spherical powder as depicted in 18 and 24 in FIG. 1.

Alternatively, the admixed elemental materials are cold pressed and sintered or spark plasma sintered under a protective atmosphere and then subsequently atomised via vacuum induction melting into spherical powder as depicted in 20 and 26 in FIG. 1.

Alternatively, as also depicted in 22 and 28 in FIG. 1, the admixed elemental materials are loose sintered without prior warm or cold pressing. The loose sintered dense- and porous billets are subsequently atomised to produce spherical powder via vacuum induction melting via electrode induction melting gas atomisation; plasma rotating electrode process and/or centrifugal atomisation.

### Example 2 Quartenary Alloys (Table 1, Example 2)

To obtain a series of quartenary baseline alloys, a mixture comprising the ternary baseline alloy and an additional transition metal element (selected from Ta, Hf, Zr, Pd, Nb) with a composition of between 5 and 25 at. % are provided. According to the invention, the admixed elements can be in granular form or comprise powder characteristics. The mixing can be achieved by ball milling or other techniques known in the art.

The series of the disclosed quartenary alloys may be processed according to the invention as disclosed in Example 1.

### Example 3 Quinary Alloys (Table 1, Example 3)

To obtain a series of quinary alloys, a mixture comprising the ternary baseline alloy and the first and second additional transition metal elements (selected from Ta, Hf, Zr, Pd, Nb) with compositions of between 5 and 25 at. % are provided. According to the invention, the admixed quinary alloys elements may be in granular form or comprise powder characteristics. The mixing can be achieved by ball milling or other techniques known in the art.

The series of the disclosed quinary alloys may be processed according to the invention as disclosed in Example 1.

### Example 4 Senary Alloy (Table 1, Example 4)

To obtain a series of senary alloys, a mixture comprising the ternary baseline alloy (in Example 1) and three additional transition metal elements (selected from Ta, Hf, Zr, Pd, Nb) with compositions of between 5 and 25 at. % are provided. The according to the invention, the admixed elements may be in granular form or comprise powder characteristics. The mixing can be achieved by ball milling or other techniques known in the art.

The series of the disclosed senary alloys may be processed according to the invention as disclosed in Example 1.

1. Process for producing powders of novel multicomponent based shape memory alloys, said alloys made by combining at least 4 to 6 elements selected from a combination of group IUPAC 4 transition metal (Ti) with group IUPAC 10 transition metals (Ni and Pt) to make up the basic ternary alloy with further additions of 1 up to 3 other transition metals making a final alloy of a maximum of 4 up to 6 components, wherein the composition of basic ternary alloy components varies between 10 and 35 at. % and 5 to 25 at. % for the 3 other transition alloying metals.

2. The process as claimed in claim 1, wherein combination includes at least Ti, Ni and Pt.

3. The process as claimed in claim 1, which process includes one or more processes selected from:
a. mechanical alloying (MA) followed by spheroidization;
b. press and sinter (P&S) followed by vacuum induction melting (VIM);
c. spark plasma sintering (SPS) followed by vacuum induction melting (VIM);
d. loose sintering followed by Electrode induction melting gas atomisation (EIGA); and
e. plasma rotating electrode process (PREP).

4. The process as claimed in claim 1, wherein the feedstock is either in powder or sponge form.

5. The process as claimed in claim 1, wherein the powders produced may be spherical in shape.

6. The process as claimed in claim 5, wherein spherical shaped powders undergo a martensitic transformation in a temperature range from 800° C. to 1500° C.

7. The process as claimed in claim 6, wherein the alloys produced have a martensitic transformation at 600° C. up to 1500° C. with a small hysteresis ranging from 10° C. to 50° C., with work output capabilities of up to 6 J/cm³ and are thermally stable.

8. The process as claimed in claim 1, wherein the alloy thus produced shows super-elasticity, work output capabilities, and high temperature mechanical and thermal stability properties on cycling.

9. Use of powders produced by combining at least 4 to 6 elements selected from a combination of group IUPAC 4 transition metal (Ti) with group IUPAC 10 transition metals (Ni and Pt) to make up a basic ternary alloy with further additions of 1 up to 3 other transition metals making a final alloy of a maximum of 4 up to 6 components, wherein the composition of basic ternary alloy components varies between 10 and 35 at. % and 5 to 25 at. % for the 3 other transition alloying metals, said powders being used for additive manufacturing (AM), metal injection moulding (MIM), or hot pressing (HP).

10. Use of powders as claimed in claim 9, which powders are produced by spheriodisation or atomisation of the final alloy.

11. Spherical powders of multicomponent based shape memory alloys, said alloys having at least 4 to 6 elements selected from a combination of group IUPAC 4 transition metal with group IUPAC 10 transition metals to make up the basic ternary alloy with further addition of 1 to 3 other transition metals making a final alloy having a maximum of 4 to 6 components, wherein said composition of basic ternary alloy components may vary between 10 and 35 at. % and 5 to 25 at. % for the up to 3 other transition alloying metals.

12. Spherical powders as claimed in claim 11, wherein the combination includes at least Ti, Ni and Pt.

13. Spherical powders as claimed in claim 11, wherein the memory alloys have a martensitic transformation in a temperature range from 800 to 1500° C.

14. Spherical powders as claimed in claim 13, wherein said memory alloys has super-elasticity, work output capabilities, and high temperature mechanical and thermal stability properties on cycling.

15. Spherical powders as claimed in claim 11, wherein the memory alloys are processed by either spheriodisation or atomisation.

16. Spherical powders as claimed in claim 12, wherein the memory alloys have a martensitic transformation in a temperature range from 800 to 1500° C.

17. Spherical powders as claimed in claim 12, wherein the memory alloys are processed by either spheriodisation or atomisation.

18. Spherical powders as claimed in claim 13, wherein the memory alloys are processed by either spheriodisation or atomisation.

19. Spherical powders as claimed in claim 14, wherein the memory alloys are processed by either spheriodisation or atomisation.
